(19) United States
(12) Patent Application Publication
(10) Pub. No.: US 2004/0160328 A1
(43) Pub. Date: Aug. 19, 2004

(54) Non-contact liquid sensing apparatus, system, and method

(75) Inventor: Dwayne Alan Becknell, Rockholds, KY (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: JACKSON, MSC., Inc.

(21) Appl. No.: 10/366,274

(22) Filed: Feb. 13, 2003

(51) Int. Cl. G08B 21/00

(52) U.S. Cl. 340/620

(57) ABSTRACT

A non-contact capacitance sensor having a base and an array disposed on the base is provided. The array has a first electrode and a second electrode disposed opposite one another so that the array senses a change in capacitance between the first and second electrodes.

### BACKGROUND OF THE INVENTION

1. Field of the Invention

The present invention is related to non-contact liquid sensing. More particularly, the present invention is related to an apparatus and method for sensing liquid used in commercial dish and glass washing machines without contacting the liquid being sensed.

2. Description of Related Art

Commercial food preparation establishments, such as restaurants and cafeterias, often use industrial or commercial washing machines for cleaning their drinking glasses, dishes, flatware, food preparation equipment, and the like. These commercial washing machines usually use one or more chemicals in the cleaning process. For example, it is common for these washing machines to use chemicals, such as, but not limited to, a detergent, a sanitizing agent, and a rinse agent, during the cleaning process.

In the use of such automated cleaning equipment, it is good sanitary practice to ensure that the chemicals needed by the washing machine during the cleaning process are, in fact, delivered to the machine. The National Sanitation Foundation (NSF) is a non-governmental organization that develops standards for public health and safety in the areas of food safety. The NSF has developed standards for commercial dish and glass washing machines (e.g., NSF Standard 3), and is currently considering modifying these standards to require chemical delivery confirmation. In order to continue to meet the increasing demands on commercial washing machines systems, new washing machines will need to be fitted with chemical delivery sensing systems. Further, and perhaps a more difficult task due to the large number of existing systems, will be retrofitting existing machines with a chemical delivery sensing system.

Conventional sensing systems are capable of sensing the presence or absence of a liquid in a conduit. However, many conventional sensing systems are contact systems, namely, they require the sensor to be installed directly in the conduit so as to contact the liquid being sensed. These contact sensing systems have proven to be ineffective in the dishwashing industry. For example, the chemicals used by commercial washing machines can be damaging to such contact sensing systems. In addition, when retrofitting washing machines that are already in use, such contact sensing systems require high cost installation, such as, cutting or replacing of existing conduits, as well as substantial labor and wiring.

Still others have developed non-contact sensing systems, which have also proven ineffective in the dishwashing industry. For example, many non-contact sensing systems are complex and can require sophisticated calibration and maintenance. Some non-contact sensing systems, such as ultrasonic sensing systems, are not effective at the low flow rates that are typically found in the chemical delivery conduits of commercial washing machines.

Accordingly, there is a continuing need for a simple, low cost liquid sensing apparatus for new and existing washing machines in order to detect the delivery of chemicals during the washing process.

### BRIEF SUMMARY OF THE INVENTION

A non-contact capacitance sensor having a base and an array disposed on the base is provided. The array has a first electrode and a second electrode disposed opposite one another so that the array senses a change in capacitance between the first and second electrodes.

A non-contact capacitance sensor having a base and a capacitance-detecting array disposed on the base is also provided. The base has at least one securing member. The capacitance-detecting array has a first electrode opposite a second electrode. The securing member is configured to secure a conduit between the first and second electrodes so that the capacitance-detecting array detects a change in capacitance indicative of a presence or an absence of a liquid in the conduit.

A system for detecting a presence or an absence of a liquid in a conduit is also provided. The system includes a first portion, a capacitance-detecting array, a securing member, and an indicator. The first portion is mountable in a desired location with respect to the conduit. The capacitance-detecting array and the securing member are disposed on the first portion. The capacitance-detecting array has a first electrode and a second electrode opposing one another. The securing member secures the conduit between the first and second electrodes so that the capacitance-detecting array detects a change in capacitance indicative of the presence or the absence of the liquid in the conduit. The indicator indicates the presence or the absence.

A method of sensing a liquid in a conduit is also provided. The method includes securing the conduit to a base so that the conduit is in a selected position with respect to a sensing array; calibrating the sensing array to a predetermined calibration level; and signaling when the sensing array detects a change from the predetermined calibration level.

A method of sensing a liquid in a conduit is also provided that includes securing the conduit in a selected position with respect to a capacitance-detecting array so that the capacitance-detecting array detects a capacitance in the conduit; calibrating the capacitance-detecting array to a predetermined calibration level; and notifying an operator when the capacitance deviates from the predetermined calibration level.

The above-described and other features and advantages of the present invention will be appreciated and understood by those skilled in the art from the following detailed description, drawings, and appended claims.

### BRIEF DESCRIPTION OF THE DRAWINGS

FIG. 1 is a schematic illustration of a liquid sensing apparatus in use with a commercial dishwashing machine;

FIG. 2 is a bottom exploded perspective view of an exemplary embodiment of a liquid sensing apparatus according to the present invention;

FIG. 3 is a front view of the liquid sensing apparatus of FIG. 2;

FIG. 4 is a top view of the liquid sensing apparatus of FIG. 2;

FIGS. 5 and 6 are opposing exploded side views of the liquid sensing apparatus of FIG. 2;

FIGS. 7 and 8 are top exploded perspective views of the liquid sensing apparatus of FIG. 2; and

FIG. 9 is an enlarged top view of circle 9-9 of FIG. 8.

### DETAILED DESCRIPTION OF THE INVENTION

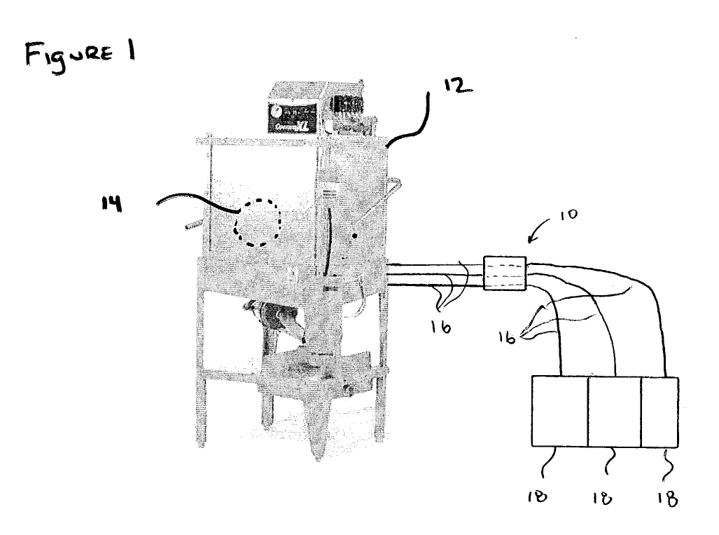

Referring now to the figures and in particular to FIG. 1, an exemplary embodiment of a liquid sensing apparatus 10 according to the present invention is schematically illustrated in use with a commercial washing machine 12. Apparatus 10 is configured to detect the presence or absence of liquid in the chemical delivery conduit(s) of machine 12 in a non-contact manner. Further, apparatus 10 is configured to be easily installed about the conduit(s) in a simple quick-connect manner. Thus, apparatus 10 offers the ability to fit new and/or retrofit existing commercial machines 12 with a chemical delivery verification means.

For purposes of clarity, machine 12 is described herein as a commercial washing machine, such as a ConserverXL Dish Washing Machine manufactured by Jackson, MSC, Inc. of Barbourville, Ky. However, it should be recognized that apparatus 10 can find use in other applications where the simple installation and use of a non-contact sensor for detecting the presence or absence of a liquid in a conduit is required.

During the cleaning process, machine 12 is adapted to treat a plurality of dishes 14 with one or more chemicals, such as, but not limited to, detergent, sanitizing agent, rinse agent, and others. Machine 12 draws or pumps liquid chemicals through conduits 16 from one or more supply containers 18 into various portions of the machine. Machine 12 is illustrated using three different liquid chemicals and, thus, having three conduits 16 and three containers 18. Of course, it is contemplated by the present invention for machine 12 to use more or less than three chemicals.

Apparatus 10 is adapted to be easily installed or connected about the exterior of conduits 16. In this installed position, apparatus 10 can be configured to sense the presence or absence of a liquid chemical in each of conduits 16 without coming into contact with the liquid passing through the conduit (i.e., non-contact). Once apparatus 10 senses an absence of liquid in any one of conduits 18, the apparatus can alarm the operator, can turn off machine 12, or both.

It has been determined that the chemicals typically used by machine 12 (e.g., detergent, sanitizing agent, rinse agent, etc.) are conductive liquids. It has also be found that conduit 16 is typically made a dielectric or non-conductive material, such as polyethylene tubing, which can withstand the properties of the chemicals used by machine 12. Accordingly, it has been determined that the capacitance of conduit 16 when the liquid is present as compared to the capacitance of the conduit when the liquid is absent can be used to detect the presence or absence of liquids in the conduit.

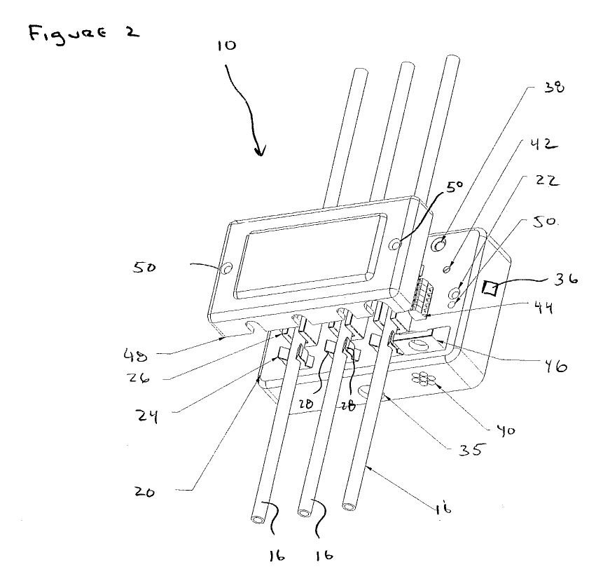

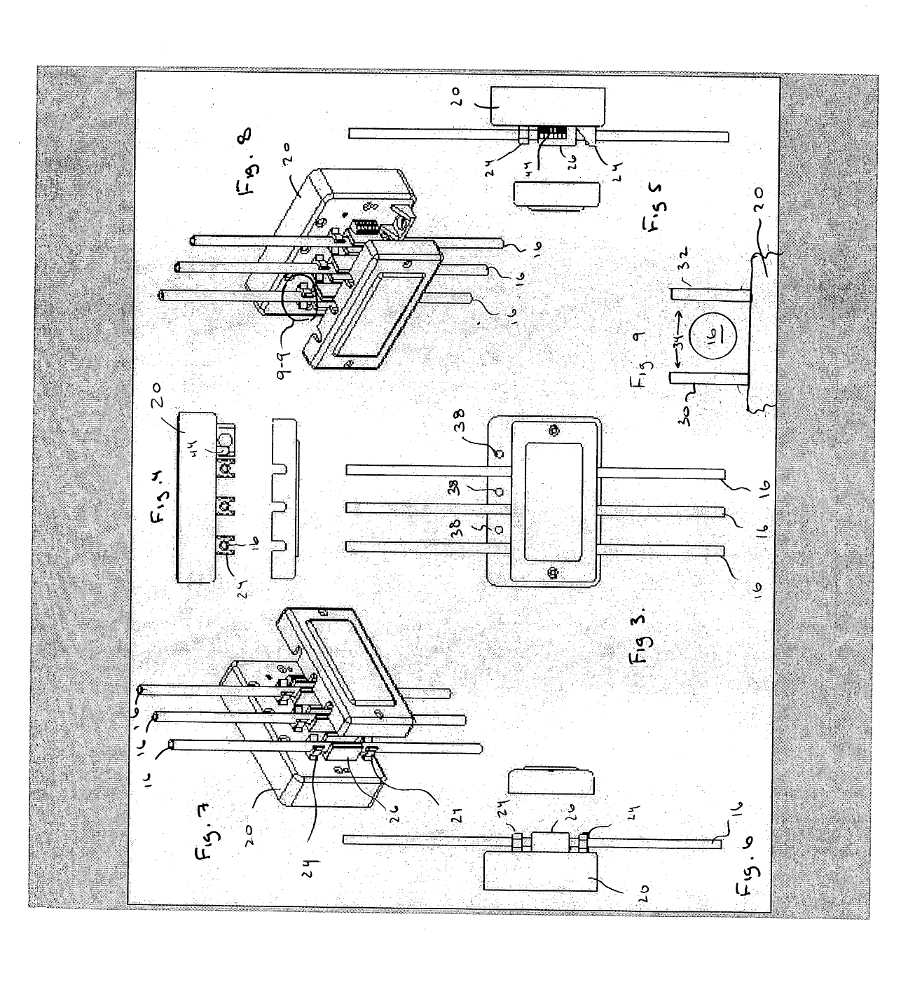

Liquid sensing apparatus 10 is described in detail below with simultaneous reference to FIGS. 2 through 9. Apparatus 10 has a first or base portion 20 configured to be mounted in a desired location, such as on a wall adjacent to containers 18. First portion 20 is preferably mounted proximate machine 12 to ensure that the liquid chemicals are delivered to machine 12. For example, first portion 20 can include one or more mounting members 22, such as, but not limited to, holes for securing first portion 20 to the desired location by way of fasteners (e.g., screws, bolts, rivots, etc.). Of course other means for mounting first portion 20 in a desired location on machine 12, such as, but not limited to, adhesives, mounting brackets, welding, hook and pile type fasteners, and others are contemplated by the present invention.

First portion 20 has one or more conduit-retaining clips or holders 24 (“clips”) and a capacitance plate array 26 for each conduit 16. Preferably, first portion 20 has two retaining clips 24 for each array 26, where clips 24 are position on opposite sides of array 26 as illustrated. In this manner, clips 24 secure conduit 16 in a desired position with respect to capacitance plate array 26. By way of example, clips 24 can have a pair of resilient biasing arms 28 configured to releasably secure conduit 16 therebetween in a snap fit manner. Of course, other releasable and non-releasable members for securing conduit 16 to first portion 20 are contemplated by the present invention.

Array 26 has a first or ground dielectric plate 30 and a second or measuring dielectric plate 32 defining a gap 34 therebetween as shown in FIG. 9. Gap 34 is, preferably, sized to be provide a minimum tolerance between conduit 16 and first and second plates 30, 32, respectively. Clips 24 are configured to maintain conduit 16 in a desired location between first and second plates 30, 32, respectively. For example, clip 24 can maintain conduit 16 in a centered relationship with respect to first and second plates 30, 32.

Apparatus 10 propagates an electric field from first plate 30 to second plate 32 through gap 34 such that any medium (i.e., conduit 16 and any liquid therein) between plates 30, 32 result in a change in the capacitance of the electric field at second plate 32. Apparatus 10 uses power from a power source (not shown) to generate the electrical field. The power source can be internal to apparatus 10, such as a battery, or can be external to the apparatus, such as a 110-volt power source. In this embodiment, first portion 20 can include a power port 35 for providing power into apparatus 10.

After conduit 16 is installed in clip 24, apparatus 10 is calibrated to detect the presence or absence of liquid in the conduit. For example, apparatus 10 can have an automatic calibration function. In this embodiment, apparatus 10 is configured to take a first reading when it is first powered up. The first reading can be representative of only conduit 16 between first and second plates 30, 32 (i.e., absence of liquid). Once the liquid becomes present in conduit 16, apparatus 10 will use its current capacitance reading as a calibration level. Apparatus 10 can then notify an operator any time apparatus 10 detects a capacitance other than the calibration level. Preferably, apparatus 10 notifies the operator any time apparatus 10 detects a change in capacitance more than a selected amount (i.e., a set point) from the calibration level. Apparatus 10 preferably has a constant set point. However, it is contemplated by the present invention for the set point to be adjustable.

In an alternate embodiment, apparatus 10 can have a manual calibration function. In this embodiment, first portion 20 can include a calibration button 36. When button 36 is depressed, apparatus 10 establishes the current detected capacitance as the calibration level. In the event that apparatus 10 is used to detect the presence of liquid in conduit 16, the operator depresses button 36 after conduit 16 is installed in first portion 20. Here, the calibration level would represent the capacitance detected by apparatus 10 of conduit 16 only. The flow of liquid through conduit 16 would cause the capacitance detected by apparatus 10 to change from the calibration level more than the set point, causing the apparatus to notify the operator. In the event that apparatus 10 is used to detect the absence of liquid in conduit 16, the operator depresses button 36 after conduit 16 is installed in first portion 20 and conduit 16 has been filled with the desired liquid. Here, the calibration level would represent the capacitance detected by apparatus 10 of both conduit 16 and the liquid. Any interruption in the flow of liquid through conduit 16 would cause the capacitance detected by apparatus 10 to change from the calibration level by a selected amount, which would cause the apparatus to notify the operator.

Apparatus 10 can notify the operator in any suitable or known manner. In one embodiment, apparatus 10 includes a visual indicator 38, such as an indicator light, for each conduit 16. Visual indicator 38 can have a first state when apparatus 10 is detecting the calibration level and a second state when the apparatus is detecting a capacitance other than the calibration level. For example, visual indicator 38 can be illuminated in green when apparatus 10 is detecting the calibration level and can be illuminated in red when the apparatus is detecting a capacitance the selected amount from the calibration level. Of course, visual indicators other illumination in green and red are contemplated by the present invention.

In another embodiment, apparatus 10 includes an audible indicator 40, such as a speaker. Audible indicator 40 can have a first state when apparatus 10 is detecting the calibration level and a second state when the apparatus is detecting a capacitance other than the calibration level. For example, audible indicator 38 can be off when apparatus 10 is detecting the calibration level and can be provide an audible noise when the apparatus is detecting a capacitance other than the calibration level. In addition, it is contemplated for apparatus 10 to include a volume control 42 for changing the sound level of audible indicator 40.

In still another embodiment, apparatus 10 includes one or more output relay connections 44. Each output relay connection 44 can be placed in electrical communication with a device external to apparatus 10. For example, an electric wire (not shown) can be used to place machine 12 in electrical communication with one of output relay connections 44. First portion 20 can further include a mounting boss 46 for securing the electric wires to apparatus 10. In this example, apparatus 10 can provide a first output to output relay connection 44 and, thus to machine 12, when apparatus 10 is detecting the calibration level. Further, apparatus 10 can provide a second output and, thus, to machine 12, when the apparatus is detecting a capacitance other than the calibration level. Here, machine 12 can be prevented from operating or stopping when apparatus 10 detects that the liquid is not present in conduit 16. It should be recognized that machine 12 is only one example of the external device that output relay connection 44 can be in electrical communication with. It is contemplated by the present invention for apparatus 10 to be in electrical communication with any desired external device via output relay connections 44.

In addition, it is contemplated by the present invention for apparatus 10 to include any combination of the forgoing means to notify the operator.

Apparatus 10 can also include a second or cover portion 48, which can be mounted to first portion 20 to protect one or more portions of the apparatus. For example, second portion 48 can be used to cover clips 24, arrays 26, and output relay connections 44. First and second portions 20, 48, respectively, can include cooperating mounting holes 50 for securing first and second portions 20, 48 to one another by way of fasteners (e.g., screws, bolts, rivots, etc.). Of course other means for securing second portion 48 over first portion 20, such as, but not limited to, adhesives, mounting brackets, welding, hook and pile type fasteners, and others are contemplated by the present invention.

As described herein apparatus 10 can be easily installed and, thus, can make the retrofitting of existing machines 12 simple and cost effective. Further, as described herein apparatus 10 can be easily incorporated into the design and installation of new machines 12. In fact, the use of apparatus 10 merely requires mounting first portion 20 in a desired location, snapping conduits 16 in clips 24, and using button 36 to calibrate the capacitance reading for the presence or absence of the desired liquid in each conduit 16. The method can further include installing second portion 48 onto first portion 20 and/or placing relay output connection(s) 44 in electrical communication with machine 12 or other external devices.

It should also be noted that the terms “first”, “second”, “third”, “upper”, “lower” and the like may be used herein to modify various elements of the present invention. It is intended that these modifiers do not imply a spatial, sequential, or hierarchical order to the modified elements unless specifically stated.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the disclosure without departing from the essential scope thereof. Therefore, it is intended that the invention not be limited to the particular embodiment(s) disclosed as the best mode contemplated for carrying out this invention, but that the invention will include all embodiments falling within the scope of the appended claims.

What is claimed is:

1. A non-contact capacitance sensor comprising:
an array disposed on a base, said array having a first electrode and a second electrode disposed opposite one another so that said array senses a change in capacitance between said first and second electrodes.

2. The sensor as in claim 1, further comprising an indicator for indicating said change.

3. The sensor as in claim 2, wherein said indicator is selected from the group consisting of a visual indicator, an audible indicator, a relay in electrical communication with a device external to the sensor, and combinations of one or more of the foregoing.

4. The sensor as in claim 3, wherein said external device is a commercial dishwashing machine.

5. The sensor as in claim 1, further comprising a securing member disposed on said base, said securing member being configured to secure a conduit between said first and second electrodes.

6. The sensor as in claim 5, wherein said change in capacitance is indicative of a presence or an absence of a liquid in said conduit.

7. The sensor as in claim 6, wherein said liquid is selected from the group consisting of a detergent, a sanitizer, a rinsing agent, and combinations of one or more of the foregoing.

8. The sensor as in claim 1, further comprising a plurality of arrays disposed on said base, wherein each array in said plurality of arrays has a first electrode and a second electrode disposed opposite one another and is capable of sensing a change in capacitance between said first and second electrodes.

9. A non-contact capacitance sensor comprising:
a base having at least one securing member; and
a capacitance-detecting array disposed on said base, said capacitance-detecting array having a first electrode opposite a second electrode, wherein said securing member is configured to secure a conduit between said first and second electrodes so that said capacitance-detecting array detects a change in capacitance indicative of a presence or an absence of a liquid in said conduit.

10. The sensor as in claim 9, further comprising an indicator for indicating said presence or said absence.

11. The sensor as in claim 10, wherein said indicator is selected from the group consisting of a visual indicator, an audible indicator, a relay in electrical communication with a device external to said sensor, and combinations of one or more of the foregoing.

12. The sensor as in claim 11, wherein said external device is a commercial dishwashing machine.

13. The sensor as in claim 9, wherein said liquid is selected from the group consisting of a detergent, a sanitizer, a rinsing agent, and combinations of one or more of the foregoing.

14. A system for detecting a presence or an absence of a liquid in a conduit, the system comprising:
a first portion mountable in a desired location with respect to said conduit;
a capacitance-detecting array disposed on said first portion, said capacitance-detecting array having a first electrode opposing a second electrode;
a securing member disposed on said first portion, said securing member being configured to secure said conduit between said first and second electrodes so that said capacitance-detecting array detects a change in capacitance indicative of said presence or said absence of said liquid in said conduit; and
an indicator for indicating said presence or said absence.

15. The system as in claim 14, further comprising a second portion for covering said first portion.

16. The system as in claim 14, wherein said indicator is selected from the group consisting of a visual indicator, an audible indicator, a relay output connection in electrical communication with an external device, and combinations of one or more of the foregoing.

17. The system as in claim 16, wherein said external device is a commercial dishwashing machine and said liquid is selected from the group consisting of a detergent, a sanitizer, a rinsing agent, and combinations of one or more of the foregoing.

18. A method of sensing a liquid in a conduit, the method comprising:
securing the conduit to a base so that the conduit is in a selected position with respect to a sensing array;
calibrating said sensing array to a predetermined calibration level; and
signaling when said sensing array detects a change from said predetermined calibration level.

19. The method as in claim 18, wherein said predetermined calibration level is indicative of a capacitance of either the conduit only or the conduit having the liquid therein.

20. The method as in claim 18, further comprising covering at least a portion of said base.

21. The method as in claim 18, wherein said signaling comprises changing a state of an indicator, said indicator being selected from the group consisting of a visual indicator, an audible indicator, a relay output connection in electrical communication with an external device, and combinations of one or more of the foregoing.

22. The method as in claim 18, wherein said sensing array comprises a first electrode spaced from a second electrode, said selected position being between said first and second electrodes.

23. A method of sensing a liquid in a conduit, the method comprising:
securing the conduit in a selected position with respect to a capacitance-detecting array so that said capacitance-detecting array detects a capacitance in the conduit;
calibrating said capacitance-detecting array to a predetermined calibration level; and
notifying an operator when said capacitance deviates from said predetermined calibration level.

24. The method as in claim 23, further comprising mounting a first portion in a desired location with respect to the conduit, said capacitance-detecting array being disposed on said first portion.

25. The method as in claim 24, wherein said first portion further comprises a plurality of capacitance-detecting arrays so that liquid in more than one conduit can be detected by said first portion.
